(19) United States
(12) Patent Application Publication
(10) Pub. No.: US 2023/0123791 A1
(43) Pub. Date: Apr. 20, 2023

(54) Curing System for Glass Repair

(71) Applicants: Shiloh Judah Spoo, Bend, OR (US); Dominik Scheffler, Phoenix, AZ (US); Ashraf Wahba, Hayward, CA (US)

(72) Inventors: Shiloh Judah Spoo, Bend, OR (US); Dominik Scheffler, Phoenix, AZ (US); Ashraf Wahba, Hayward, CA (US)

(21) Appl. No.: 17/969,294

(22) Filed: Oct. 19, 2022

Related U.S. Application Data
(60) Provisional application No. 63/257,339, filed on Oct. 19, 2021.

(51) Int. Cl. E04G 23/02; H05B 47/16

(52) U.S. Cl. CPC E04G 23/02; H05B 47/16

(57) ABSTRACT

A curing device is positionable to a mount on a resin injector to cure the resin injected into a defect in glass. A housing of the curing device is removably positionable to a mounted position on the resin injector. When in the mounted position the curing device positions a light area from light emitters to an area surrounding the nozzle of the injector to provide curing of the injected resin. A GPS locator can ascertain a location, date, and time of use of the curing device and store such use information in electronic memory.

### BACKGROUND OF THE INVENTION

### 1. Field of the Invention

This application claims priority to U.S. Provisional Pat. application serial number 63/257,339 filed on Oct. 19, 2021, which is incorporated herein in its entirety by this reference thereto.

The present invention relates generally to the repair of cracks formed in laminated glass products. More particularly, the invention relates to a curing system for resins employed to repair glass cracks and defects, which is adapted for positioning adjacent a resin injector and communicating curing light emissions to the injected side to properly cure the resin.

### 2. Prior Art

Laminated glass consists generally of a plurality of layers of glass and one or a plurality of layers of a tough plastic material or resin operatively engaged thereto. When such laminated glass is impacted and broken, the glass portions are held in place by the resin interlayer between the two or more layers of glass. Thus, the interlayer maintains the layers of glass bonded even when broken, and its toughening prevents the glass from breaking up into large sharp pieces.

Laminated glass is normally used when there is a possibility of human impact or where the glass could fall, if shattered. Skylight glazing and automobile windshields typically use laminated glass. In geographical areas requiring hurricane-resistant construction, laminated glass is often used in exterior storefronts, curtain walls, and windows.

Vehicle windshields are formed conventionally in this type of construction and are probably one of the most common conventional forms of laminated glass. Hereafter, while the laminated glass may be referred to as a windshield or pane for ease of description and convenience, such a reference will also apply to any type of glass having such a laminated construction.

As previously mentioned, laminated glass, such as a windshield for a vehicle, is commonly constructed of two glass layers and an intermediate layer of tough plastic. When a conventional windshield formed of such laminated glass is struck at a point on its outer surface, a break is usually formed. Such breaks frequently take the form of a bulls eye or a star and can initially have small cracks radiating from a point, opening on the surface outwardly and downwardly through the outer lamination of the resin interface. Where laminated glass is impacted to form a small bulls eye or star without further cracking across the entire pane or windshield, it is conventionally well known that larger cracks tend to subsequently develop over time, if the initial impact point is not repaired.

When such damage occurs to the windshield, various contaminants including air and moisture may become trapped between the two layers of glass. These contaminants can alter the refractive index of the windshield thereby obscuring or impeding the vision of a driver. Also, these damages will weaken the windshield compromising the structural integrity of the windshield and its ability to properly support the structure of the vehicle.

Differing methods and devices have been developed over many years which enable such small impact craters and cracks to be repaired. Such repairs produce generally clear viewing through the glass and also provide adherence of resins to help prevent long cracks from developing across the pane or windshield.

In the repair of laminated glass such as a windshield, conventionally an injector is employed to inject a chosen resin into the defect in the laminated glass at the impact point. Such resins are especially well formulated to adhere to the surface of the crack or ding or defect and to, thereafter, hold them together to prevent further cracking.

Once a chosen resin is properly injected into the crack or defect and the air removed during the process, the resin must be cured. Such curing is conventionally accomplished using light emitters which communicate light to the resin in a wavelength to cause it to cure and harden to an adhered positioning. The finished repair, as noted, will help prevent further cracking and in most cases will also repair the optical viewing characteristics of the pane or windshield.

Various prior art injection devices are adapted to generate a vacuum by manipulating an injector piston by either threading or pulling up and locking the injection piston in relation to the injection housing. Thereafter, the resin is injected into the defective area.

With the resin properly filling the void or defect in the glass, thereafter a curing light must be positioned wherein light emitters will communicate the proper light wavelengths to the resin to cure it, and for the proper amount of time. The time needed for the cure can vary due to ambient temperature, the thickness of the glass, and the type of resin employed, and once cured, the windshield or laminated glass will generally have a clear viewing therethrough and be inhibited from further cracking.

The forgoing examples of related art, as to resin injection systems for repair of laminated glass, and the limitations related therewith, are intended to be illustrative and not exclusive, and they do not imply any limitations on the invention described and claimed herein. Various other limitations in the related art of laminated glass repair will become apparent to those skilled in the art upon a reading and understanding of the specification below and the accompanying drawings.

### SUMMARY OF THE INVENTION

The resin curing device and system herein disclosed and described provides significant improvement and utility for the task of communicating the proper light frequency to resin which has been injected into cracks and defects of laminated glass.

Conventional resin injectors are adapted to achieve a removable mount upon the glass, such as a windshield. Preferably, this removable mount positions the injection area of the resin injector in communication with the crack or defect in the laminated glass. This allows the user to employ the injector to both pull a vacuum of sorts from the void that is the defect in the glass and subsequently inject the chosen resin into that defect with the injector still removably engaged for the whole process.

Conventionally, the user, employing the injector to repair such a defect, will choose a particular resin from a number available, based on the type of glass being repaired, and/or the type and size of the defect therein. The user must then determine the cure time for the injected resin, and employ a light emitter with the correct light emissions range, such as 350-380 nanometers, to cure the resin, for the correct amount of time required to do so. Frequently, the user must ascertain if the ambient temperature may require increased cure time, and in some cases where the glass is thicker or tinted, cure time adjustments for such also.

The curing device herein has a housing to which a plurality of curing light emitters are operatively engaged for projecting curing light emissions toward and into the resin, once it has been injected into a crack or defect. In a particularly preferred configuration of the device herein, the housing is configured to mount over an already-mounted injector on a windshield or the like, without the need to remove the injector. This can be an important feature in that it allows the user to maintain the injector in sealed contact with the windshield and injection site of the nozzle and maintain the injected resin within the crack or defect through the continued seal of the injector.

This piggy back or over-nesting ability of the device to mount on an injector herein is provided by a central passage which is configured to surround and slide over an upright portion of the resin injector which is engaged with support legs having suction cups or other removable attachment to the glass being repaired. A lower edge of the housing of the device herein, has a plurality of recesses formed therein which are positioned to align with the support leg members which hold the injector in place.

During the process of positioning the housing of the device herein to a mounted position, the central passage will allow the injector to project therethrough and the formed recesses provide respective passages through the sidewall of the housing for the leg or support members of the injector. Thus, once the housing of the device herein has been slid upon and over the resin injector, the injector nozzle maintains the engagement to the windshield or glass, and a removable mount such as a suction cup engaged to the housing will hold the device in an engaged position relative to both the injector and windshield, with the injector nested thereunder. Once in this mounted or engaged position, light emitters on the housing are registered in position to automatically focus and form a light area of curing light emission, which contacts and surrounds the area in which resin has been injected into the glass by the injector nozzle of the injector.

In use, the device herein will be placed in this engaged or mounted position once the chosen resin has been injected into the glass. In this mounted position, the curing device herein will operate to communicate light from light emitters, to the glass in an area or pattern over and surrounding the injection nozzle, and thereby cure the resin previously injected into the glass defective area. The positioning of the housing of the device in the mounted position on a resin injector, automatically positions the emitters thereon to form the illumination area in the correct position at and surrounding the injector nozzle.

In one mode of the device, the user will activate the curing process by contact with or by depressing an activation switch. A timer can simply activate the light emitters for a duration of time known to cure the resin. By timer herein is meant an actual timer which will count a time duration and activate and deactivate the electric power to the light emitters, or simply a switch to control the electric power which is controlled by software running in electronic memory on a computer device, which will signal the switch to communicate electric power for a duration of time.

Alternatively, at the time of activation, software operating to the task of ascertaining a current battery voltage level of the onboard power supply for operatively engaged light emitters will determine if sufficient energy is stored in the battery for the curing process.

If it is determined by the software configured to ascertain the power stored in the battery that sufficient power is present, then the user can activate the curing process herein by depressing an activation button which may be a longer depression duration of the same button employed for on/off activation or may be a separate button or switch. However, should the onboard software running in electronic memory and a computer processor determine a low power problem exists, a warning or charging light will flash indicating charging is required. A charger can then be engaged using a charging port positioned on the housing and operatively connected with an onboard rechargeable battery or slow discharge capacitor or the like. To let the user know charging is occurring, the charging light will blink until the software monitoring battery power determines it is sufficiently charged, and thereafter a signal will be given the user by actuating the charging light to stay illuminated and cease blinking.

Once the device is sufficiently charged with electric power, if it is not in the mounted position, it will be placed in such as described above. However, it can both be charged and operated with the charger plugged into the charging port while in the mounted position and surrounding the resin injector.

The device can be energized to illuminate the plurality of onboard light emitters, for a set duration of time, by the pressing of an activation button for such, or by depressing the on/off button or switch, once the device has been activated. The curing durations may be set by an onboard timer for set time durations. Sequential durations may be activated sequentially by pressing the activation button to achieve longer durations of curing time.

In this automatic mode, tapping the curing activation button once will cause the emitters to energize and emit curing light for a first set duration, for example 30 seconds. Tapping the activation button twice will cause the device to energize the emitters for a different time duration, such as 15 seconds. In this manner, the user can determine, from experience or written instructions, the proper duration to activate for one or sequential equal durations of time.

The user will be aware that automatic curing is underway from the light emitters which are illuminated for the duration of the curing process. Once finished, the housing for the device is disengaged from its mounted position, covering and surrounding the resin injector and mount therefor.

In this, and all modes of operation of the device herein, the user can maintain the resin injector in sealed contact against the injection site on the windshield or window during the entire curing process and if required, during engagement of a charger to the charging port. The device will operate with just the charger connected to the charging port should the user not wish to expend the time duration required to charge the onboard battery or capacitor or the like.

In enhanced modes of the device and the system herein, it may be equipped with additional sensors and software operating to perform the tasks required to operate the additional enhancements. In one particularly preferred mode of the device, a temperature sensor is positioned on the housing which will sense and determine the ambient surrounding temperature. Running software in electronic memory operatively engaged to a computer processor, a current ambient temperature will be determined based on the signal communicated to the computer processor from the temperature sensor.

Using this ambient determined temperature, software running to the task of curing calculation, will ascertain from files or a database held in onboard electronic memory, the proper duration of time for curing the resin being used in this ambient temperature. Thereafter, the duration of time which the curing light emitters are energized will be adjusted to insure a proper curing of the resin based on the match of the determined ambient temperature to the curing time held in electronic memory relating to that determined ambient temperature. This mode is highly preferred, as most, if not all, polymers or resins do not cure as quickly when the working conditions are very cold and cure more quickly in hot temperatures. So, the auto adjustment takes the guess work out of operation for the user when operating in cold and hot conditions.

In yet another mode of the device having enhanced operation, a sensor may be mounted on the housing to determine a proper curing time based on a thickness of the glass being repaired or a size of the defect. In this mode, an optical sensor engaged upon the housing will receive reflected light from the repair area while the repair area is illuminated by either non-curing light from emitters or a very short burst of curing light from emitters. Using the signals from the optical sensor which is receiving reflected light from the glass, an area of the injected resin may be determined by calculating the pixels in the area of the resin and defect. Alternatively, the light reflected from a thick or tinted glass which might affect curing can also be ascertained by the optical sensor signals, which are communicated to the computer processor. Software running to the task of determining the area of the resin to be cured and/or determining any glass thickness or tinting issues which might change the required curing time, will then ascertain a proper curing time using stored information in electronic memory which will relate the electronic signals from the optical sensor to proper curing times previously determined as matching such. The system will then automatically adjust the cure time to that determined proper.

In another mode of the device and system herein, a glass temperature sensor is provided which works either by contact or more preferably without contact using for example, an infrared sensor to detect infrared light emitted by the glass. The infrared thermometer in conventional operation employs a lens to focus the infrared light emitting from an object such as the glass, onto a detector such as a thermopile. The thermopile will generate an output voltage relative to the infrared light emitted. Voltage output is produced in proportion to the incident infrared energy. The detector thus uses this output to determine the temperature of the glass being repaired. This glass temperature can be employed in combination with ambient temperature or by itself to adjust the curing time of the chosen resin material.

Another particularly preferred component of the curing device herein, is the positioning and angling of the light emitters employed to emit curing light, such that they emit the curing light in a defined pattern. Currently, an elongated rectangular pattern is preferred as it provides an enlarged area into which to position the resin filled crack or defect for curing.

Additionally, where a rectangle or other shaped emitter illumination is employed, the device herein may be provided with a targeting sequence for low power emission from the curing emitters or from one or more targeting emitters projecting visible light in a non-curing wavelength. The user can activate the projection of the rectangle or other targeting illumination onto the glass to check their positioning to make sure the curing lights will best illuminate the resin, by pressing a targeting activation button.

In another particularly preferred mode of the device and system herein, a location sensor herein, referred to as a GPS receiver, will be included on the housing. The location sensor will be operating to determine a geographic location of the curing device on the date it is being used and can include the time based on the GPS signal received. This information, relative to location and date of use, can be stored in onboard electronic memory.

The location and date information, so stored, can also be communicated to the service provider for whom the technician works, to inform them that the resin injection and curing has occurred at a geographic location and date, determined by the GPS. This geolocation and date of use information can be used in real time to ascertain if an appointment is being filled, and afterwards to show the geographic locations where the resin injection and curing occurred for each device, and the dates on which each such curing of resin on a glass surface occurred. A wireless transmitter, positioned on the device, can be activated to communicate a location of use on a date and time, such as over cellular communications channels or local WiFi.

Where the GPS location determination is or is not included, it is preferable that the device employs software adapted to determine each actual use of the curing light, and to associate each use with the date and time, the curing light was activated. Each time the curing light is activated this activation will cause the software to store in accessible electronic memory, a use and the date and preferably the time of day, such occurred. This use information can be also associated with the GPS location of each such use if GPS is included.

The counting of the number of uses is helpful to determine resin use and possible need to resupply the technician with the injection and curing device. A counter, which may be mechanical or software operated, may be included on the device. Each activation of the device for use, by activating the light emitters, can be associated with the terrestrial location of the device along with the date and time determined from the GPS signal. This information is employable to track where the injection and curing occurred to cross reference such with customers ordering such to make sure their order for a repair has been filled. An onboard wireless transmitter can be employed to communicate this use information to the service provider over cellular, wireless, bluetooth or other wireless communications channels. This will allow the system provider to calculate resin replenishment requirements as well as track and confirm that jobs, assigned a technician user, are completed.

Other enhancements which may be included in a mode of the device, providing additional utility, can include a timer which is a switch engaged with the computer processor to communicate a duration of time the device has been activated. After a predetermined duration of time has passed, software running in electronic memory connected to the computer processor will cause the processor to emit a signal to the on/off switch or circuit to de-energize the device and turn it off. Such allows for the inclusion of temperature sensors and software running to change the duration of time, based on ambient or glass temperatures sensed.

An additional enhanced component, which is particularly preferred for use of the device in hot climates and areas, is a temperature sensor which can monitor the circuits and components while the device is energized. Should an operating temperature above a predetermined level be determined from electronic signals from the temperature monitor to the computer processor, temperature monitoring software thereon or a temperature activated switch will cause the device to turn off to protect it from overheating.

Finally, the device can include a locking feature. With this feature included, the user will be able to depress a locking activation button or depress the on/off switch, noted above, for a duration of time, to cause the device to turn off and stay off and de-energized until the user again presses the activation button or switch to energize it. This feature will keep the device from accidentally activating, should it be bumped or dripped during transit between jobs.

With respect to the above description, before explaining at least one preferred embodiment of the herein disclosed resin curing invention in detail, it is to be understood that it is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other resin curing emitters which are adapted for positioning over a mounted resin injector without removing such, and the structures, methods and systems for carrying out the several purposes of the present disclosed resin curing device for glass repairs. It is important, therefore, that the claims be regarded as including such equivalent construction and methodology insofar as they do not depart from the spirit and scope of the present invention.

It is an object of this invention to provide a resin curing light device for use with a resin injector which engages with the resin injector to a mounted position which automatically locates the emitted curing light area to illuminate all of the area of resin injection into the underlying glass.

It is a further object of this invention to include temperature sensors in the housing which communicate one or both of the ambient temperature and glass temperature to the device, wherein software running to the task of curing time calculation will adjust how long the curing lights are illuminated based on the temperature sensed.

The objects, features, and advantages of the present invention, as well as the advantages thereof over existing prior art, which will become apparent from the description to follow, are accomplished by the improvements described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures herein are to be considered illustrative of the glass repair mounting system herein, rather than limiting.

In the drawings: FIG. 1 depicts the resin curing device herein which is configured for operative positioning over and in combination with a resin injector mounted upon glass being repaired, such as a windshield.

FIG. 2 is an overhead perspective view of the housing of the device of FIG. 1 showing the central passage communicating therethrough.

FIG. 3 shows another overhead view of the device of FIGS. 1-2 showing the charging port and recesses formed into the lower edge of the sidewall to accommodate mounting members of the injector of FIG. 1.

FIG. 4 shows a side view of the housing of the device herein and also shows the passages formed in the housing sidewall to allow it to operatively engage over a mounted resin injector.

FIG. 5 depicts a top view of the housing showing a central passage there

FIG. 6 shows a lower side view of the housing showing the plurality of light emitters positioned to communicate light to the resin in wavelengths to cure it and showing a preferred pattern for the light communicated.

FIG. 7 depicts a lower side view of the housing of the device in a mode which includes an optical sensor configured to communicate electronic signals relative to reflected light from the windshield.

FIG. 8 shows a glass-mounted resin injector over which the device herein will mount without removal of the injector.

FIG. 9 shows the device herein, in the disengaged position, being slid over the resin injector toward the mounted position, as in FIG. 10.

FIG. 10 shows the device herein in the mounted position atop the injector for resin, and wherein so mounted it operates to project the pattern of light to cure injected resin in the area into which the resin was injected into the glass.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

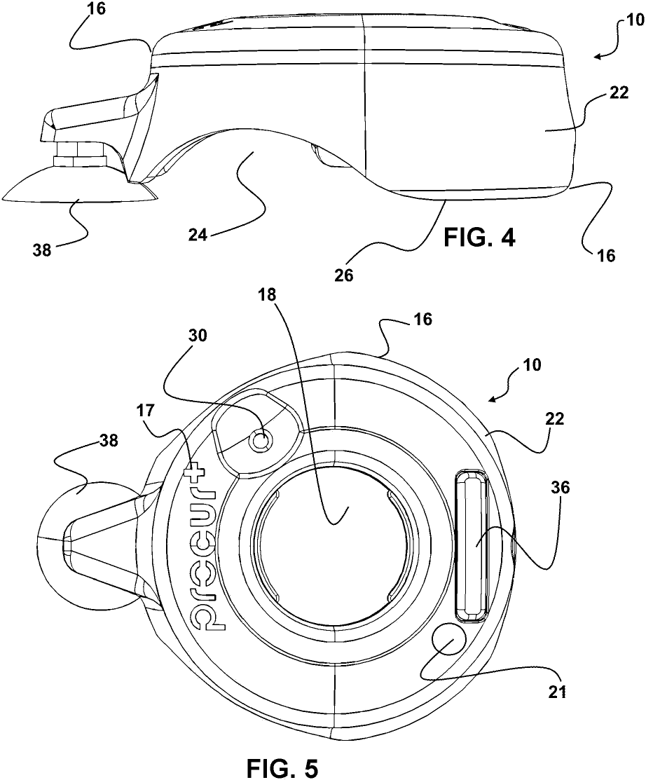

Now referring to drawings in FIGS. 1-10, wherein similar components are identified by like reference numerals, there can be seen in FIG. 1 the resin curing device 10 herein which is configured for operative nested or mounted positioning upon a resin injector 12 which has been previously operatively positioned on the glass 14, such as a windshield having a crack or defect into which resin has been injected from an injector nozzle 13.

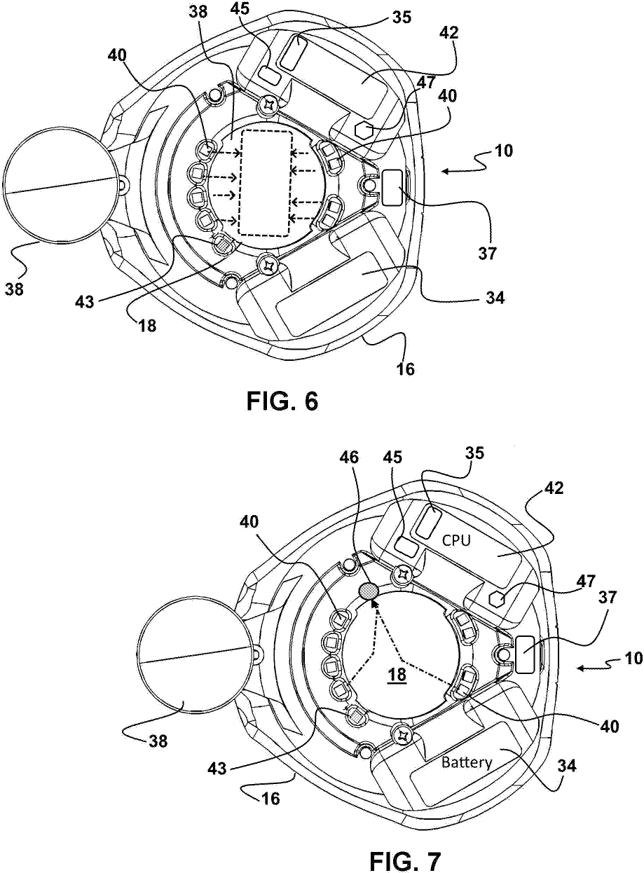

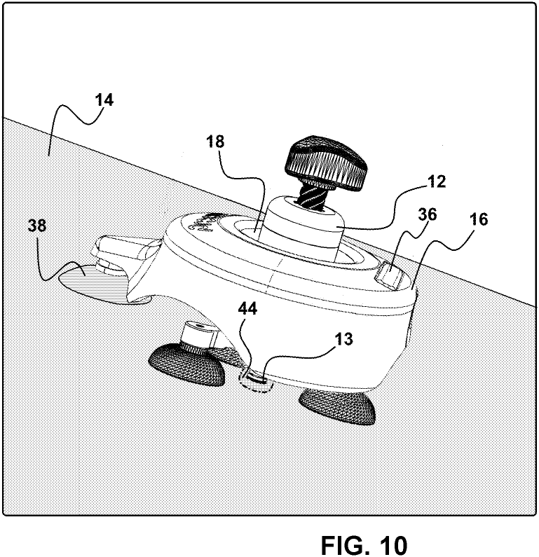

This configuration, providing for a connection of the housing 16 of the device 10 to the injector 12 in a mounted positioning of the device 10 upon the injector 12, as in FIG. 10, is especially preferred. In this mounted positioning, the device 10 is mounted on the resin injector 12 in a connection thereto, wherein a projected curing light area 44 (FIGS. 6 and 10), will be automatically registered in position. By registered in position is meant that the projected curing light area 44, in its communication to the glass 14, with the device 10 in the mounted position on the injector 12, will illuminate, substantially, the entire area of the glass 14, such as a windshield, into which resin has been injected by the injector nozzle 13. The device 10 is, thus, automatically aimed when positioned in the mounted position on an injector 12, such as in FIG. 10, such that no adjustment is required of the user to make sure the light area 44 having a pattern or shape on the glass 14, as communicated from the light emitters 40, will illuminate the entire area of the glass 14 into which resin has been injected.

As shown in FIGS. 1-10, the device 10 features a housing 16 which is specifically configured to nest or mount upon an already mounted injector 12. Conventionally, such an injector 12 will be engaged to the glass 14 to locate the injector nozzle 13 in position to inject resin into the glass 14. A central passage 18 communicates between an upper surface 20 of the housing and a lower surface, as shown in FIGS. 5-7. This central passage 18 is sized to allow positioning of a projecting portion 15 of the resin injector 12 therethrough. Action lights 17 are positioned on the housing 16 which, as noted above, can be activated to blink and/or remain illuminated for determined time periods to communicate to the user a current action of the device 10 during use.

As can be seen in FIG. 1 and FIGS. 3-4, the housing 16 has a sidewall 22 which surrounds the upper surface 20 thereof. The sidewall 22 has the plurality of recesses 24 formed into the sidewall 22 which extend upward from a lower edge 26 of the sidewall 22 which may contact against the glass 14 when the housing and device 10 are operatively positioned in a mounted position, such as in FIG. 10. As noted, so positioned, each of the recesses 24 define a passageway through which one of the leg members 28 (FIG. 1), which support the injector 12 in an engaged position on the glass 14, can project.

Of course, other connections of the device 10 to an injector 12 may be employed, as would occur to those skilled in the art such as magnets or cooperative connectors, where one half of the connector is on the injector 12 and the other is on the housing 16, and such is anticipated. For example, the base and leg members 28, which support an injector 12, could be differently shaped and configured, wherein the housing 16 herein would be configured with the requisite central passage 18 and recesses 24 in positions to align therewith to allow such an over-mount or nesting mount of the device 10 with injectors 12 of other configurations. However, currently, the disclosed housing 16 with a sidewall 22 to protect the user from light emissions and easily engaged central passage 18 is preferred.

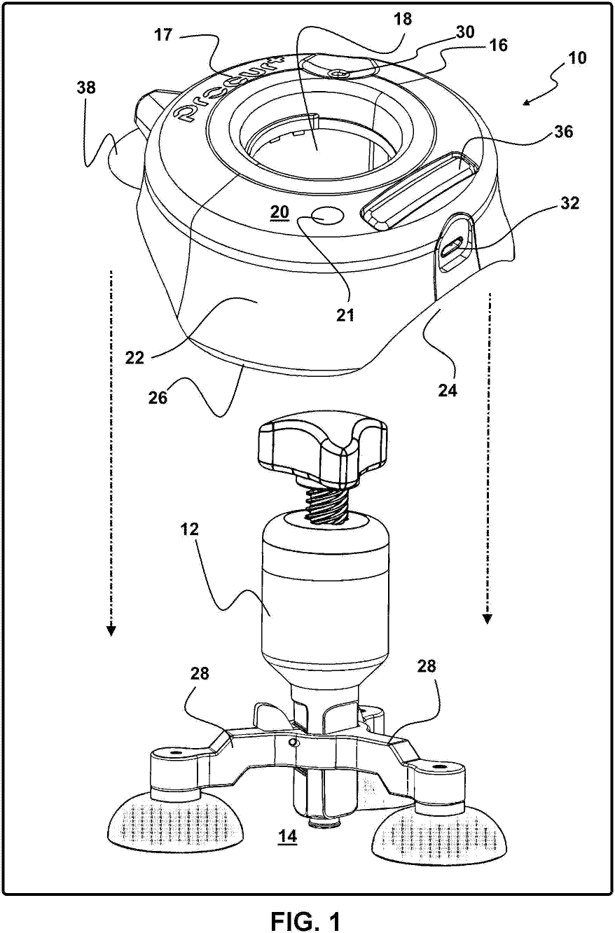

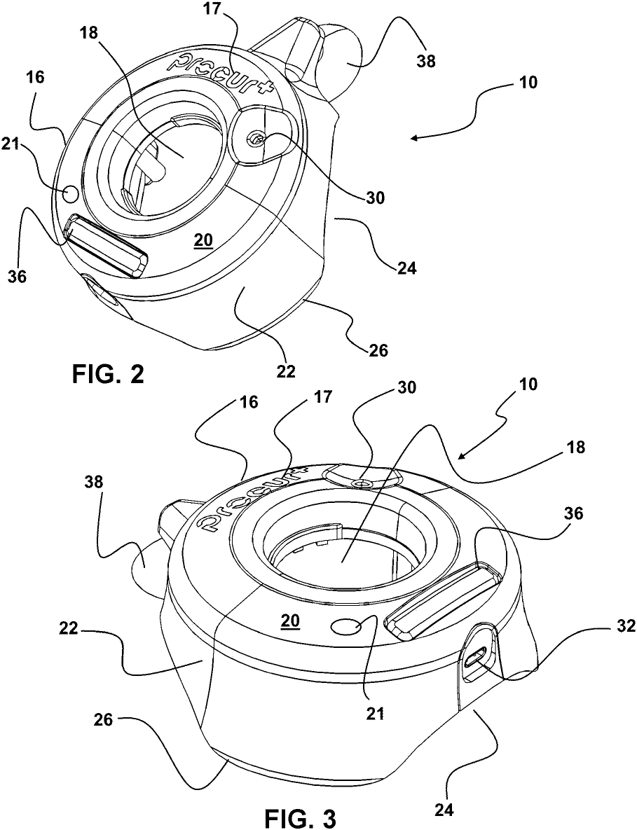

In FIGS. 2-3 and 5 herein are shown various overhead views of the top surface 10 of the housing 16 of the device 10 herein. As can be seen, the central passage 18 communicates through the housing 16. Also shown in the figures is an ambient temperature sensor 30 which, as noted, is preferred. This allows software, running to the task of adjusting the light emission curing time, to make corrections for local temperature.

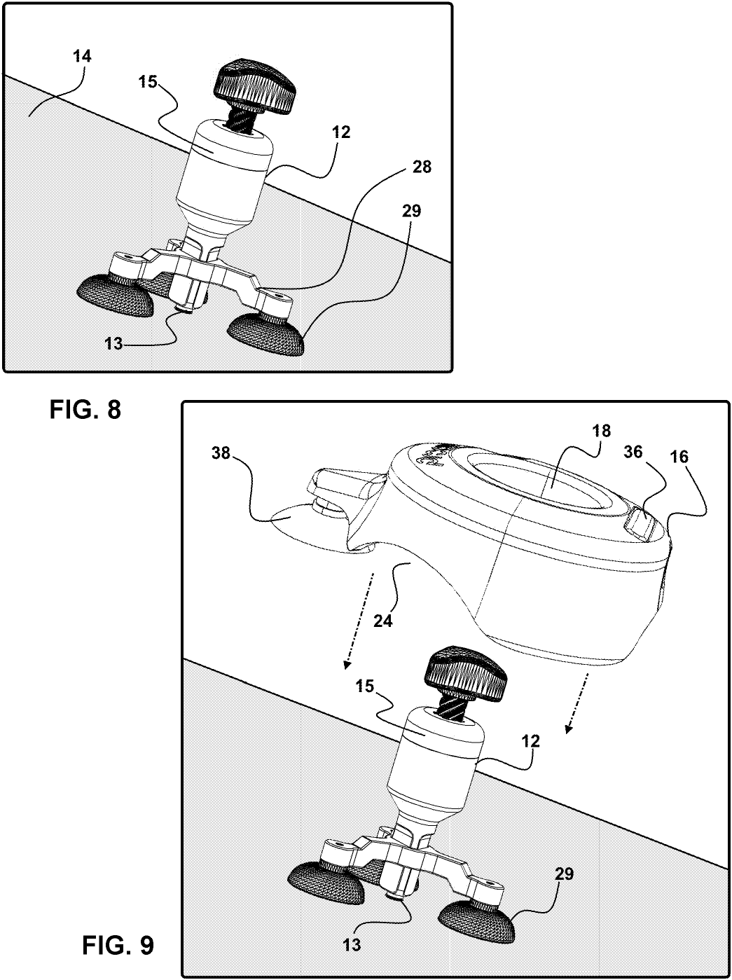

In FIG. 2 is also shown a power port 32 which is employable to power the device 10 directly during use or to recharge an onboard power supply, such as a battery 34 (FIGS. 8-9). Also shown are an activation button 36, which can be any shape and in other positions on the housing 16 and which is employed, as noted above, for various activation and timing inputs to the device 10. Also shown is a removably engageable support for the device 10 to the glass 14, such as a suction cup 38. The suction cup 38 or other removably engageable mount will hold the device 10 in the mounted position surrounding and covering a resin injector 12, such as in FIG. 12.

Shown in FIG. 6 is a view of a bottom side of the device 10 wherein a plurality of light emitters 40 are positioned around the side edge of the central passage 18. As noted, the emitters 40 are powered by an onboard power supply, such as the battery 34, and can be activated, as noted above, for different time durations and sequences by user activation of the activation button 36 and/or by software running in electronic memory 35 of a computer processor 42 operatively engaged between the battery 34 and the light emitters 40 to activate switches to illuminate the light emitters 40 for time durations adapted to cure the resin already positioned in the glass 14 by the injector 12. The actuation of the activation button 36 will cause an onboard timer switch 37 to connect electric power from the battery 34 or other electric power source to the light emitters 40 for a duration of time which can be preset. As noted, multiple actuations of the activation button 36 can cause the timer switch 37 to connect the electric power to the light emitters 40 for sequential durations of time or shortened durations. Also, by timer switch 37 herein is meant, any actuable timer switch to control the communication of electric power to the light emitters 40 for a duration of time. Such may not need to be a physical timer but can also be provided by software running in electronic memory 45 accessible by the computer processor 42, which will control a timer switch 37 to communicate and interrupt the electric power to the light emitters 40 to thereby energize them for the duration of time needed for curing resin.

Additionally shown in FIGS. 6 and 7, is a glass temperature sensor 43 which, as noted above, will use optical or mechanical readings, or both, from the adjacent glass 14 to output a signal relative to the current glass temperature. This glass temperature reading, as noted, can be employed by software running in electronic memory 35 of the device 10 to calculate a proper duration for illumination of the light emitters 40 to cure the resin injected into the glass 14. As noted above, the glass temperature sensor 43 outputs an electronic signal relative to the current temperature of the glass 14 it has discerned. It is this electronic signal which is employable to determine or adjust the duration of illumination of the light emitters to adjust the curing time for the resin injected into the glass 14 by the resin injector 12.

As noted above, a counter 45 to count the number of uses of the device 10 to cure resin injected by a resin injector 12 is also a preferred component and function. The counter 45 may be mechanical or may be provided by software running in electronic memory 35 of the device 10 to track and count each use where the light emitters 40 have been activated. The counter will hold a running total of the number of such uses until erased by the user. Each such use, captured by the counter 45, can be associated with a GPS terrestrial location provided by the GPS sensor 21 along with the date of the use and GPS location. Such dates are easily ascertained by the GPS sensor 21 since GPS location data includes time and dates. Software running in electronic memory 35 to the task of ascertaining location from the GPS data received can, thus, correlate the time and date along with the location for each activation of the light emitters 40 to cure resin.

The activation by the user using the activation button 36 or other means for activation, can concurrently trigger the GPS sensor 21 to take the GPS location reading as to terrestrial location and the date and time, and associate it with each use held by the counter 45. This use information, including one or a combination of location, use, date, and time information, can be communicated to the service provider using the wireless transmitter 47 which can employ cellular wireless transmissions and/or Wifi or Bluetooth transmissions, or other wireless transmissions of the data. Also, the same use information can be downloaded from electronic memory 34 using an access port, such as the power port 32 where it is a USB connection.

Particularly preferred in the device 10 herein is the formation of a light area 44 or a pattern of the light projected from the emitters 40 onto the glass 14 which will contact and surround the entire area of the underlying glass 14 adjacent the injector nozzle 13 having resin injected therein. Currently, an elongated rectangle shape or area is preferred, as it provides a well defined and large area for the user to position the device 10 such that the resin is fully illuminated and cured. This light area 44 may also be used as a target, as noted above, for the user to check the positioning of the device 10 prior to starting the curing process.

However, it should also be noted that because the housing 16, once in the mounted position such as in FIG. 10, locates the light emitters 40 to the proper registered position to form the light area 44 to contact with and surround the resin injected by the nozzle injector 13, the device 10 herein requires no adjustment once the user has mounted the injector 12 in position. This is because, as noted, this mounted position automatically locates the light area 44 in the proper position to surround the nozzle 13 which is on the defect to be filled with resin, along with a surrounding area. This is most preferred since it eliminates mis-targeting automatically.

As noted, shown in FIG. 7 is a lower side view of the housing 16 of the device in a mode which includes an optical sensor 46 configured to communicate electronic signals relative to reflected light from the emitters 40 or emitters projecting light in other frequencies best adapted to reflect from the windshield or glass 14, and allow software adapted to the task of thickness determination, and/or resin injected area, to provide the data to software running to the task of adjusting curing times to calculate an optimum curing time for the injected resin.

As noted above, the device 10 is configured for an over mount of a resin injector 12 which is already in a mounted position on the glass 14 or windshield. This process of achieving such a nesting or registered mount in combination with the resin injector 12, is shown in the sequence in FIGS. 8-10. As shown in FIG. 8, the resin injector 12 is mounted on the glass 14 windshield using removable mounts, such as suction cups 29, to hold it in the properly mounted position where the injector nozzle 13 is sealed against the glass 14 upon the underlying defect into which resin is injected.

Shown in FIG. 9 is the positioning of the device 10 by sliding the central passage 18 of the housing 16 over and around the projecting portion 15 of the resin injector 12. The bottom of the housing 16 is then positioned atop the leg members 28 of the resin injector 12 which is already removably mounted on the glass 14. A secondary suction cup 38 is employable to removably hold the housing 16 in position, if needed. This locates the housing 16 to the mounted position of FIG. 10 wherein, as noted, the light emitters 40 will be automatically located to form the light area 44 which positions the curing light upon and around the area in which the nozzle 13 has injected resin into the glass 14.

While all of the fundamental characteristics and features of the resin curing device herein which engages over a mounted resin injector have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A curing apparatus for curing resin injected into a defect in glass by a resin injector, comprising:
a housing, said housing having an upper side and a lower side opposite said upper side;
said housing positionable to a mounted position upon a resin injector positioned upon glass being repaired;
said housing having one or a plurality of light emitters positioned on said lower side, said light emitters for emitting light therefrom in a light wavelength which cures resin injected into said glass by said resin injector;
an electric power supply positioned on said housing to provide electric power to said light emitters; and
an activator, said activator, when actuated, connecting said electric power to said light emitters to thereby cause said light therefrom to be communicated to said resin for a duration of time, whereby said resin is cured by said light from said light emitters.

2. The curing apparatus of claim 1, additionally including:
said housing positioned in said mounted position locating said light emitters to a registered position; and
said light emitters in said registered position projecting said light therefrom to a lighting area on said glass, said lighting area illuminating a glass area of said glass which surrounds an injector nozzle of said resin injector, to thereby automatically locate said lighting area to a position to complexly cure all of said resin.

3. The curing apparatus of claim 1, additionally comprising:
a timer, said timer activated by said actuator; and
said timer, when activated, connecting said electric power to said light emitters for said duration of time.

4. The curing apparatus of claim 2, additionally comprising:
a timer, said timer activated by said actuator; and
said timer, when activated, connecting said electric power to said light emitters for said duration of time.

5. The curing apparatus of claim 3, additionally comprising:
a computer processor operatively in communication with electronic memory and with electric power from said battery;
a temperature sensor for determining the ambient temperature adjacent said housing;
software operating in said electronic memory to the task of ascertaining a calculated said duration of time based upon a communication from said temperature sensor of said ambient temperature discerned by said temperature sensor; and
said timer in communication with said computer processor wherein said timer connects said electric power to said light emitters for said calculated duration of time.

6. The curing apparatus of claim 4, additionally comprising:
a computer processor operatively in communication with electronic memory and with electric power from said battery;
a temperature sensor for determining the ambient temperature adjacent said housing;
software operating in said electronic memory to the task of ascertaining a calculated said duration of time based upon a communication from said temperature sensor of said ambient temperature discerned by said temperature sensor; and
said timer in communication with said computer processor wherein said timer connects said electric power to said light emitters for said calculated duration of time.

7. The curing apparatus of claim 5, additionally comprising:
a GPS sensor positioned on said housing;
said actuator, when actuated, causing said GPS sensor to ascertain a terrestrial location of said housing from a received GPS signal; and
a respective said terrestrial location of said housing correlating to each actuation of said actuator being stored in said electronic memory as use information.

8. The curing apparatus of claim 6, additionally comprising:
a GPS sensor positioned on said housing;
said actuator, when actuated, causing said GPS sensor to ascertain a terrestrial location of said housing from a received GPS signal; and
a respective said terrestrial location of said housing correlating to each actuation of said actuator being stored in said electronic memory as use information.

9. The curing apparatus of claim 7, additionally comprising:
said actuator, when actuated, causing said GPS sensor to additionally ascertain a date and time when said actuator is actuated from said received GPS signal; and
said date and time of each said respective said terrestrial location of said housing correlating to each actuation of said actuator being stored in said electronic memory as use information.

10. The curing apparatus of claim 8, additionally comprising:
said actuator, when actuated, causing said GPS sensor to additionally ascertain a date and time when said actuator is actuated from said received GPS signal; and
said date and time of each said respective said terrestrial location of said housing correlating to each actuation of said actuator being stored in said electronic memory as use information.

11. The curing apparatus of claim 3, additionally comprising:
a computer processor operatively in communication with electronic memory and with electric power from said battery;
said housing having a glass temperature sensor for determining a current temperature of said glass;
software operating in said electronic memory to the task of ascertaining a calculated said duration of time based upon a communication from said glass temperature sensor of said current temperature of said glass; and
said timer in communication with said computer processor wherein said timer connects said electric power to said light emitters for said calculated duration of time.

12. The curing apparatus of claim 4, additionally comprising:
a computer processor operatively in communication with electronic memory and with electric power from said battery;
said housing having a glass temperature sensor for determining a current temperature of said glass;
software operating in said electronic memory to the task of ascertaining a calculated said duration of time based upon a communication from said glass temperature sensor of said current temperature of said glass; and
said timer in communication with said computer processor wherein said timer connects said electric power to said light emitters for said calculated duration of time.

13. The curing apparatus of claim 11, additionally comprising:
a GPS sensor positioned on said housing;
said actuator, when actuated, causing said GPS sensor to ascertain a terrestrial location of said housing from a received GPS signal; and
a respective said terrestrial location of said housing correlating to each actuation of said actuator being stored in said electronic memory as use information.

14. The curing apparatus of claim 12, additionally comprising:
a GPS sensor positioned on said housing;
said actuator, when actuated, causing said GPS sensor to ascertain a terrestrial location of said housing from a received GPS signal; and
a respective said terrestrial location of said housing correlating to each actuation of said actuator being stored in said electronic memory as use information.
